(19) United States
(12) Patent Application Publication
(10) Pub. No.: US 2008/0133233 A1
(43) Pub. Date: Jun. 5, 2008

(54) MEDICAL ASSISTANCE DEVICE

(75) Inventor: Shinichi TSUBURA, Nasushiobara-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignees: KABUSHIKI KAISHA TOSHIBA, Tokyo (JP); TOSHIBA MEDICAL SYSTEMS CORPORATION, Otawara-shi (JP)

(21) Appl. No.: 11/944,547

(22) Filed: Nov. 23, 2007

(30) Foreign Application Priority Data
Dec. 1, 2006 (JP) 2006-325483

(51) Int. Cl. G06Q 99/00; G06Q 50/00; G10L 15/26

(52) U.S. Cl. 704/235; 705/2; 704/E15.045

(57) ABSTRACT

A medical assistance device comprises: a voice dictionary used for transforming voice into characters; a storage configured to store cipher information indicating correspondence of terms included in the voice dictionary and the terms for ciphering; a voice entering part configured to enter voice; a transformer configured to transform the entered voice into a term string, based on the voice dictionary and the cipher information; a display transformer configured to transform the transformed term string into information for display; and a display controller configured to instruct a display device to display the information for display.

### BACKGROUND OF THE INVENTION

1. Field of the Invention

The present invention relates to a medical support system configured to record text data inputted by using voice recognition to an electronic medical chart or a medical report.

2. Description of the Relates Art

In recent years, as seen in an electronic medical chart, a reporting apparatus for interpretation, and so on, computerization of items entered by doctors has advanced. Then, such a computerized input system has been introduced to many medical institutions. In general, the electronic medical chart or the like is created by doctors directly inputting a sentence by using a keyboard, or inputting a sentence by selecting a predetermined fixed phrase and so on, resulting in burden on the doctors who input the information.

Further, the doctor also needs to perform a complicated medical practice such as an operation and an examination, and the doctors performing such a medical practice are forced to make various motions with both hands. An example of the complicated medical practice is an endoscopic examination. The endoscopic examination is an examination for diagnosing an affected area by inserting an endoscope into a body and passing the endoscope inside the body while observing examination images sent from the endoscope. These examination images can be collected into an image server via a network.

However, in the conventional endoscopic examination, it is difficult to manually input text information because the doctor operates the endoscope by both hands. On the other hand, in the endoscopic examination, a place desired to examine is not specified, and it is required to survey a considerably wide range where the affected part may exist. For example, an upper digestive organ examination requires inspections of esophagus, duodenum, and the introductory part of small intestine. Moreover, since images sent from the endoscope are of epithelium mostly composed of mucosa membrane, similar images of a red-color tube of a vascular system are continuously sent. For example, in the case of treatment of polyps by an endoscopic therapy in accordance with the endoscopic examination, when the polyps are located at a plurality of places and eliminated at one time, the doctor is responsible for memorizing the places of the eliminated polyps. However, since similar images of a wide range are continuously sent as mentioned above, it is difficult to memorize the similar images and specify the places thereof later. Moreover, since there are a variety of treatments in the endoscopic examination, such as an observation diagnosis, staining, biopsy, a request for a pathological examination, and air insertion, the doctor needs to memorize not only the treated places but also all names of diseases. Therefore, what the doctor should memorize increases, and it is considered to be difficult to correctly reproduce the result of the endoscopic examination from the doctor's memory alone. Besides, in a bronchoscopic examination, the doctor needs to remember branches of the bronchus through which the endoscope has been passed from among a huge number of the branches. In reporting after the examination, it takes much labor to reproduce the examination even if images have been taken. Thus, in a complicated medical practice that does not allow the doctor to input on site, it places a heavy burden on the doctor to input information on the medical practice after the medical practice ends.

Then, techniques for a dictation function used for creation of an electronic medical chart or the like by voice-recognizing the content of findings and converting to text data have been proposed so far, such as a system supporting input of an electronic medical chart by voice recognition for reducing burden on the doctor by input into an electronic medical chart (for example, Japanese Unexamined Patent Application Publication JP-A 2005-149083), a system reporting by voice recognition for reducing burden on the doctor by input when reporting for interpretation (for example, Japanese Unexamined Patent Application Publication JP-A 2004-118098), and a medical support system for supporting a complicated medical practice such as an endoscopic examination (for example, Japanese Unexamined Patent Application Publication JP-A 2006-218230, and Japanese Unexamined Patent Application Publication JP-A 2006-221583). These techniques have reduced the burden on the doctors by input of information.

Here, voice recognition is to: recognize sound in an acoustical space and convert into acoustic segments; in accordance with the HMM (Hidden Markov Model) of an acoustic model, perform a statistical morphological analysis called N-gram processing by using a language model, and determine a word with the maximum appearance probability at sound/language levels as a recognition result; subject the recognized language to natural language processing based on the previous and next words and context as a sentence; and output as a sentence of a final recognition result. Here, information that describes a language to be voice-recognized for the N-gram processing and the natural language processing is referred to as voice dictionaries, or simply, dictionaries. Here, the voice dictionaries include a word dictionary, a sound segment dictionary, a sound phone dictionary, a sound word dictionary, a language dictionary, a natural language dictionary, and a user voice dictionary that contains user-specific habits.

The aforementioned techniques enable the doctors to input necessary information only by uttering words without directly inputting the information by hand, thereby reducing the burden on the doctors by input of the information. However, a patient is awake, and recently, the patient watches the same monitor as the doctor and listens to what the doctor and nurse talk. Then, the patient can recognize the doctor's words at the time of voice input, and the patient may be shocked when the doctor utters serious words like “suspected of gastric cancer.” Meanwhile, in the case of using secret codes understood only by the doctors, the doctors need to convert the secret codes into ordinary words when, for example, reporting later. Eventually, it becomes difficult to reduce the burden on the doctor.

### SUMMARY OF THE INVENTION

The present invention is based on the above-mentioned situation. The present invention is intended to provide a medical assistance device that transforms the language used in front of the patient into a proper language in accordance with the situation of diagnosis and examination at the time of text transformation by means of voice recognition, so as to instruct an electric medical chart or a reporting device to display the language.

The first aspect of the present invention comprises: a voice dictionary used for transforming voice into characters; a storage configured to store cipher information indicating correspondence of terms included in the voice dictionary and the terms for ciphering; a voice entering part configured to enter voice; a transformer configured to transform the entered voice into a term string, based on the voice dictionary and the cipher information; a display transformer configured to transform the transformed term string into information for display; and a display controller configured to instruct a display device to display the information for display. This technique is applicable to a medical assistance device.

The second aspect of the present invention is a medical assistance device comprising: voice dictionary used for transforming voice into characters; a storage configured to storing cipher information (cipher table) indicating correspondence of terms included in the voice dictionary and the terms for ciphering; a voice entering part configured to enter voice; a transformer configured to transform the entered voice into a term string, based on the voice dictionary and the cipher information; a display transformer configured to transform the transformed term string into information for display; and a display controller configured to instruct a display device to display the information for display, wherein the transformer is configured to refer to correspondence of the term registered beforehand and other term string, for transformation into other term string. This technique is also applicable to a medical assistance device.

In the first aspect of the medical assistance device of the present embodiment, doctors do not have to enter the medical information manually, and can enter voice on the moment, so as to reduce the burden of the doctor in entering the medical information and memorizing. Further, the display content can be changed depending on the entered transformation condition, and the statistical voice recognition and the natural language processing are used to transform voice into characters, therefore precisely transforming it into proper characters. Further, the ciphered information is used to display the transformed language on screen without showing the language uttered depending on the situation of usage. For example, on the screen directly visible to the patient, not the name of the disease but the language of the state is displayed. As a result, medical assistance depending on the situation of usage, e.g. the medical assistance that does not prompt fear of the patient, can be provided.

In the second aspect of the medical assistance device of the present embodiment, doctors do not have to enter the medical information manually, and can enter voice on the moment, so as to reduce the burden of the doctor in entering the medical information and memorizing. Further, the transformation is enabled with low load, and the content can be displayed depending on the entered transformation condition, so as to provide the medical assistance according to the situation of usage.

### BRIEF DESCRIPTION OF THE DRAWINGS

FIG. 1 is a block diagram of a medical assistance device related to the present invention.

FIG. 2 is a diagram of procedure flow of examination using endoscope.

FIG. 3 is a diagram of explaining transformation condition.

FIG. 4 is a diagram of explaining a screen used for creating reports.

FIG. 5 is a flowchart of transforming entered voice into characters.

### DETAILED DESCRIPTION OF THE EMBODIMENTS

### The First Embodiment

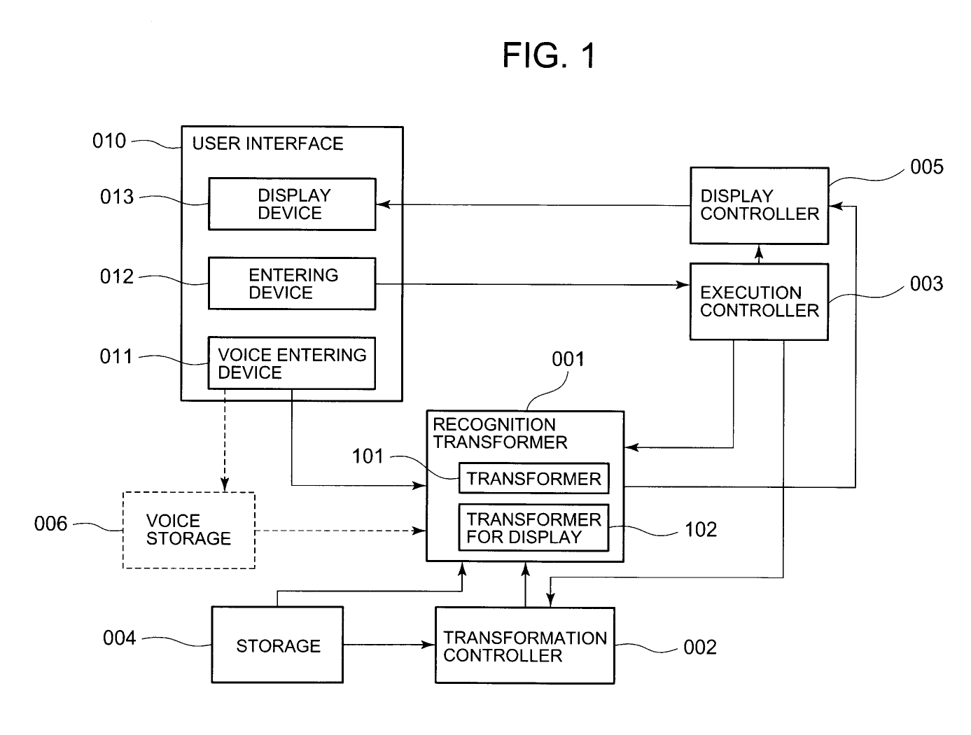

Hereinafter, a medical assistance device related to the first embodiment of the present invention will be explained. FIG. 1 is a block diagram showing features of a medical assistance device related to the present invention. As shown in FIG. 1, an execution controller 003, a recognition transformer 001, and a transformation controller 002 are respectively implemented by CPU. Further, the medical assistance device, as shown in FIG. 1, includes a display device 013 such as a monitor, an entering device 012 such as a keyboard or a mouse, and a voice entering device 01 1 such as a microphone, as a user interface 010.

First of all, a manufacturer provides a group of dictionaries (hereinafter, referred to as basic dictionaries group) used to recognize voice as a term without change in a storage 004. It should be noted that the dictionaries group is information group describing a language for voice recognition. This basic dictionaries group includes an acoustic model for recognizing correspondence of each voice in a voice element of 50 voices (Japanese syllabary). A language model for defining voice production by vocabulary, grammar or language statistics, is also included.

Further, in the acoustic model and the language model, voice dictionaries group including terminology is included, categorized to a radiologist, a cardiovascular doctor, a pathology examination, an examination of physiology and an endoscope, pharmaceutical section and diagnosis section. Also, dictionaries group is included, segmentalized in sites (e.g. for breast, abdomen and cephalic part) or in specialities (e.g. circulatory organ, respiratory organ, cranial nerve and physiologic/pathologic/pharmaceutical). Dictionaries group to determine a term from this sound composed of the acoustic model and the language model is explained as “voice dictionary” in this embodiment. Hereinafter, the basic dictionaries group which the medical assistance device manufacturer provides in a storage will be fixed for usage in the present embodiment. Meanwhile, the basic dictionaries group may provide a function for renewing the acoustic model and/or the language model by automatic learning. As a result, accuracy of recognizing entered voice as a term can be improved.

Further, the medical assistance device manufacturer previously registers a plurality of terms to be used as a cipher (hereinafter, referred to as ciphered term) from terms registered in basic dictionaries group and provides them in a storage 004. This ciphered term is explained as “term used for ciphering” in this embodiment. The ciphered term may be combination of two terms.

Then, dictionaries group, for returning the ciphered term to the term of original meaning regarding the registered ciphered term, is registered and provided in the storage 004 and then the correspondence of the ciphered term and the dictionaries group for use is also provided in the storage 004. For example, to register the term “red swelling” as a ciphered term, the medical assistance device manufacturer first registers the term “red swelling” as a ciphered term and associates the language “red swelling” with a dictionary for returning the ciphered term to the term of original meaning. The dictionary can be used to transform it into “stomach cancer Boltzmann IIa suspected” or “physiologic examination required”. The stored relationship between these ciphered terms and the dictionary including terms of original meaning will be explained as “ciphered information” in this embodiment. Note that this dictionary is used not only for transforming the language “red swelling” into the above exemplified two languages, but for statistically analyzing it based on anteroposterior term and the flow of context and transforming it into the language if it corresponds to the above two examples.

Note that the term registered and ciphered in advance by the medical assistance device manufacturer is used as a cipher in this embodiment, while the user may register this ciphered term so that the term can be used as a cipher. Accordingly, the term suitable to each user can be used as a ciphered term, and therefore accurate transformation from voice into characters suitable for each user as well as contributing to efficiency of medical treatment are enabled.

These dictionaries groups are updated so that voice is transformed into characters more accurately by learning the state of usage by an operator i.e. correspondence of entered voice and the term required by the operator.

Further, the medical assistance device manufacturer in advance provides correspondence of transformation condition for transforming entered voice into characters, and the dictionaries group in the storage 004. Note that the transformation condition is a condition to determine characters into which certain voice is to be transformed when the voice is entered. For example, based on this transformation condition, it is determined whether transforming the language “red swelling” into “stomach cancer Boltzmann IIa suspected” or “physiologic examination required”.

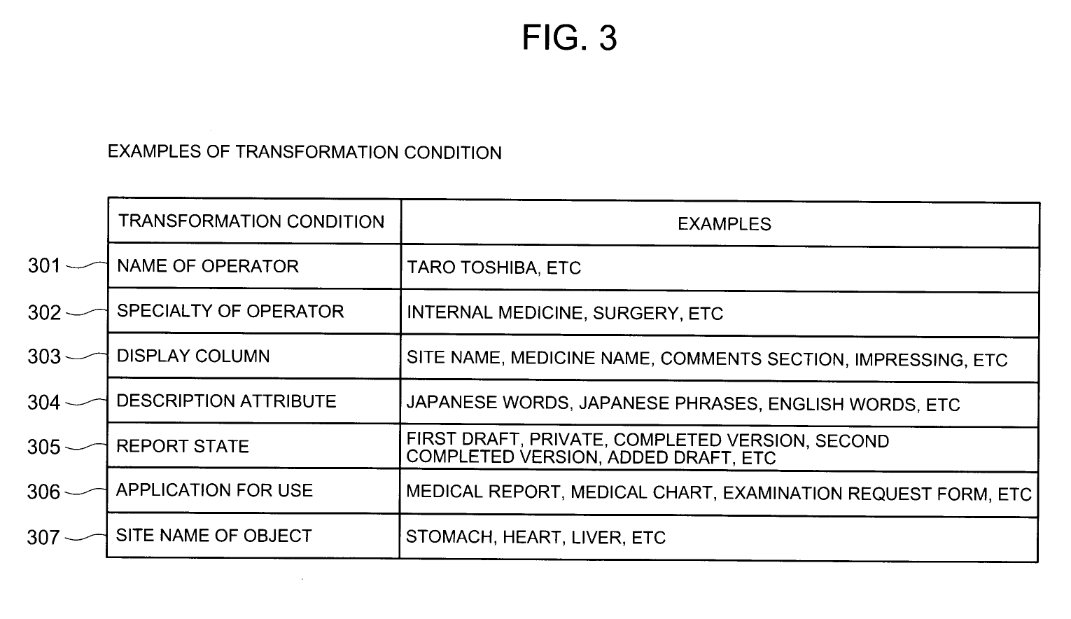

In response to usage of the entering device 012 by an operator for entering, based on order information indicating information of what kind of examination is applied and whom the examination is applied to, which is created in advance through history taking, and information of the examinee (hereinafter, simply referred to as “order information”), the execution controller 003 obtains the transformation condition shown in FIG. 3 for transforming the voice into characters.

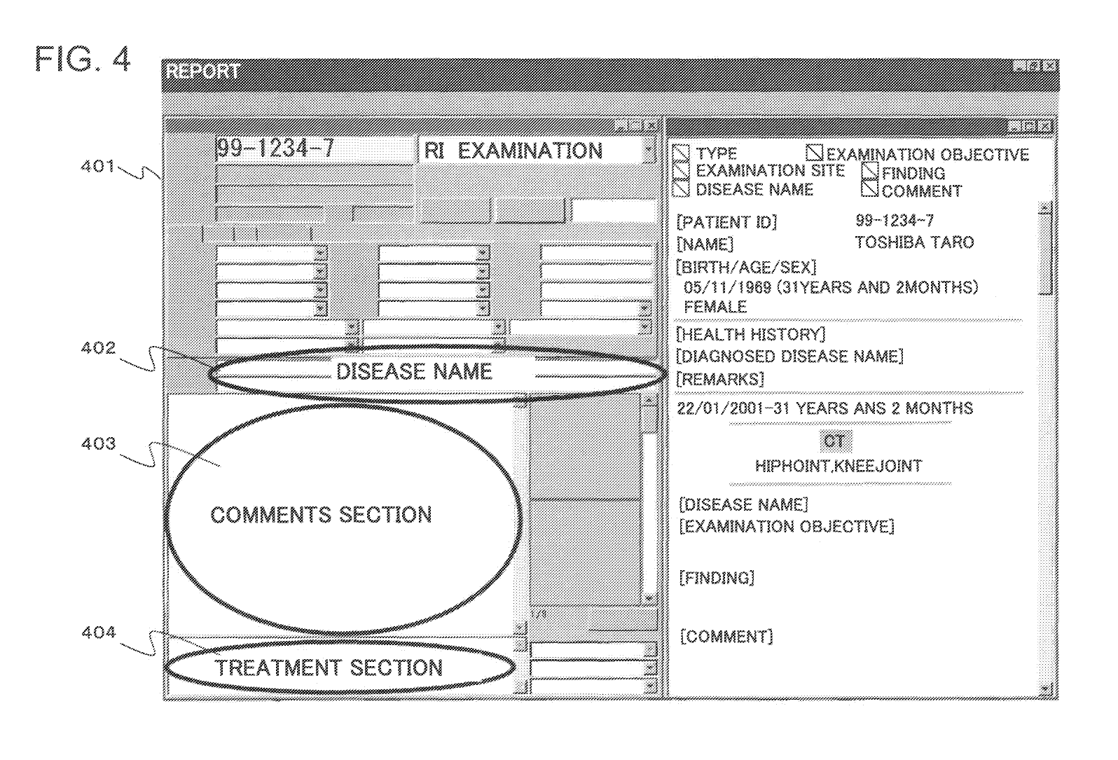

Note that 301-307 of FIG. 3 is a variety of transformation condition and its example. The name of an operator 301 is the name of doctors who use the voice entering device to enter medical information and is obtained from login information to the examination device. The specialty of the operator 302 is the specialty of the doctor who is the operator, e.g. internal medicine, surgery. Regarding display column 303, for example, there are report 401 shown in FIG. 4 includes disease name 402 to write the disease name itself, comments section 403 to write classification of diagnostic symptom and treatment section 404 to write the treatment to be applied against diagnosed symptom. The display column 303 is information of which of display columns are applied to. FIG. 4 is a diagram of explaining a screen used for creating reports. Description attribute 304 in the column of FIG. 3 is information of language to describe the report. Report state 305 is information of the current state in the process of creating report, e.g. first draft, which is the state of comments description by the first attending doctor.

The application for use 306 indicates an application used for displaying medical information of a patient on the display device 013. It is information of the application causing the display device 013 to display characters transformed from voice as medical information, such as a variety selected from following: an application for displaying it at the side of a patient during endoscope examination; an application used during creating report; and an application used during creating electric medical chart.

Site name of object 307 is information of site to be examined. One or more voice dictionaries exist corresponding to combination of transformation conditions. For example, when a dictionary for combination of transformation conditions with internal medicine and comments section is used, the language “red swelling” is transformed into “stomach cancer Boltzmann IIa suspected”. When a dictionary for combination of transformation conditions with internal medicine and impressing is used, the language “red swelling” is transformed i n to “biopsy treatment using endoscope”. When a dictionary for combination of transformation conditions of surgery and impressing is used, the language “red swelling” is transformed into “possibility of isolating operation of stomach, consideration necessary”. As indicated above, depending on the combination of transformation conditions, a language after transformation would be different in spite of the same original language. The combination of transformation conditions or relation of dictionaries for use to any one of them, are stored in the transformation controller 002 as a table.

Note that information of the display column 303 is entered by the operator in this embodiment, while the execution controller 003 may be configured to refer to the application 306 based on information of designated application for use 306, so as to obtain information of the display column 303 to display characters, from the application 306.

The execution controller 303 initiates the application in response to instruction about the application for use by an operator. The transformation controller 002 receives information of transformation conditions for transforming entered voice into characters.

Next, the transformation controller 002 selects from the transformation condition a plurality of dictionaries (hereinafter, sets of dictionaries may be referred to as dictionaries group) for use to transform the term, so as to send instructions of using the selected dictionaries group to the recognition transformer 001.

For example, when the language “red swelling” is entered as voice, the transformation controller 002 refers to the transformation condition sent from the execution controller 003. Then, the transformation controller 002 refers to correspondence of the transformation condition and the dictionaries group stored in the storage 004, to determine which dictionaries group should be used. As an example, assume that the transformation condition is as follows: an application to create “report 401” shown in FIG. 4, description in “comments section 403” in report 401, “internal medicine” as the specialty of the operator, and “stomach” as the name of the site.

In this case, the transformation controller 002 determines as follows: that the dictionary is necessary which returns the ciphered term to the term of the original meaning because of “report 401”, that the dictionary is necessary which transforms voice into category of diagnostic symptom because of “comments column 403”; that the dictionary corresponding to the term for internal medicine is necessary because of “internal medicine”; and that the dictionary about the stomach is necessary because “stomach” is the object. Therefore, the transformation controller 002 selects the dictionaries group that satisfies the conditions. It should be noted that dictionary selection under certain transformation condition is explained here as an example, however the dictionary selection is not limited to this and therefore as other example, the dictionary is used which transforms voice into a term of the treatment suitable for symptom determined from the voice, if “treatment section 404” of the report 401 shown in FIG. 4 is required.

The recognition transformer 001 is composed of the transformer 101 and the transformer for display 102. The dictionaries group selected by the recognition transformer 001 and the transformation controller 002, and the correspondence of ciphered term stored in the storage 004 and dictionaries group for use, are referred. Therefore, the dictionary for returning it to the original meaning is selected, and the basic dictionary and the dictionary for returning it to the original meaning are used to transform the voice entered by the voice entering device 011 into characters. Specifically, the voice entered by the transformer 101 from the voice entering device 011 is transformed into the symbol corresponding to the voice using the basic dictionary. This symbol is explained as “term line” in this embodiment.

Then, to the transformed symbol, the transformer for display 102 applies the dictionary for returning it to the original meaning, in order to transform it into the characters for display (information for display). In other words, it is transformed into characters string which can be recognized by human being. For example, assume that the ciphered term “red swelling” is entered as voice, and the transformation condition includes: an application for creating “report 401”; describing it in “comments section 403” of the report 401; that the specialty of the operator is “internal medicine”; and the name of the site is “stomach”. First, since “red swelling” is registered as a ciphered term, the correspondence of ciphered term stored in the storage 004 and dictionaries group for use, is referred. Next, among dictionaries group selected by the transformation controller 002, the dictionary for returning the ciphered term “red swelling” into the original meaning is used, so as to transform “red swelling” into the language “stomach cancer Boltzmann IIa suspected”. This is because it is determined that category of diagnostic symptom is described in the comments section 403 of the report 401, and no direct attention by the patient allows the comments by the doctor to be directly described there.

The recognition transformer 001 sends characters transformed from voice to the display controller 005. The display controller 005, based on the application and the display column which are designated from the execution controller 003, instructs the display device 013 to display the characters received from the recognition controller 001.

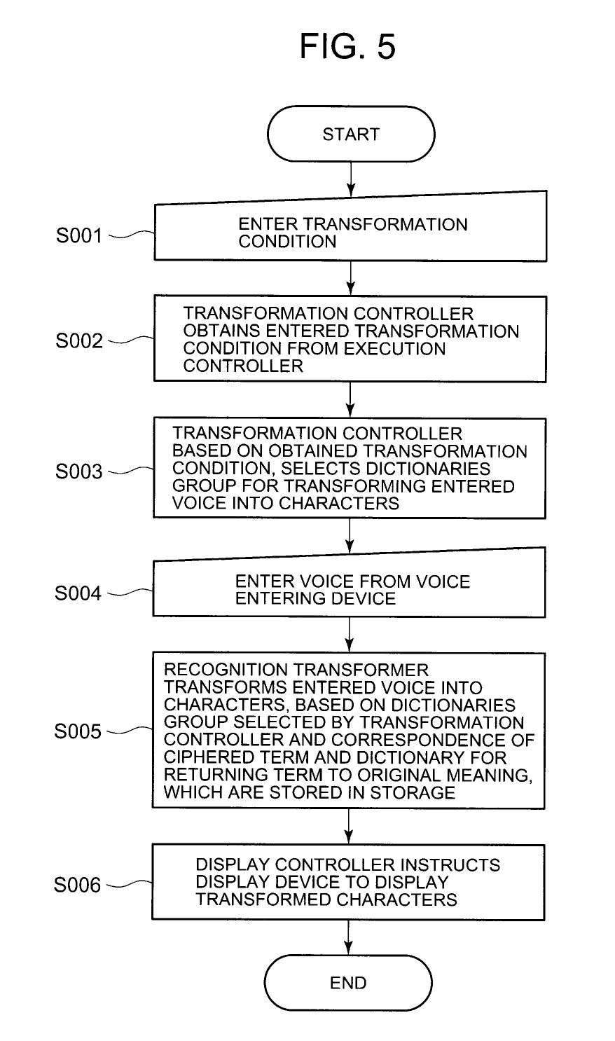

Next, transformation flow of entered voice into characters with reference of FIG. 5 will be explained. Here, FIG. 5 is a flowchart showing transformation action of the entered voice into characters.

Step S001: The operator enters a transformation condition from the entering device 012 or an order information.

Step S002: The transformation controller 002 obtains the entered transformation condition from the execution controller 003.

Step S003: The transformation controller 002, based on the obtained transformation condition, selects the dictionaries group for transforming the entered voice into characters.

Step S004: The operator enters voice from the voice entering device 011.

Step S005: The recognition transformer 001 transforms the entered voice into characters, based on the dictionaries group selected by the transformation controller 002 and the correspondence of the ciphered term and the dictionary for returning the term to the original meaning, which are stored in the storage 004.

Step S006: The display controller 005 receives the transformed characters from the recognition transformer 001 and instructs the display device 013 to display it based on the application and the display column obtained from the execution controller 003.

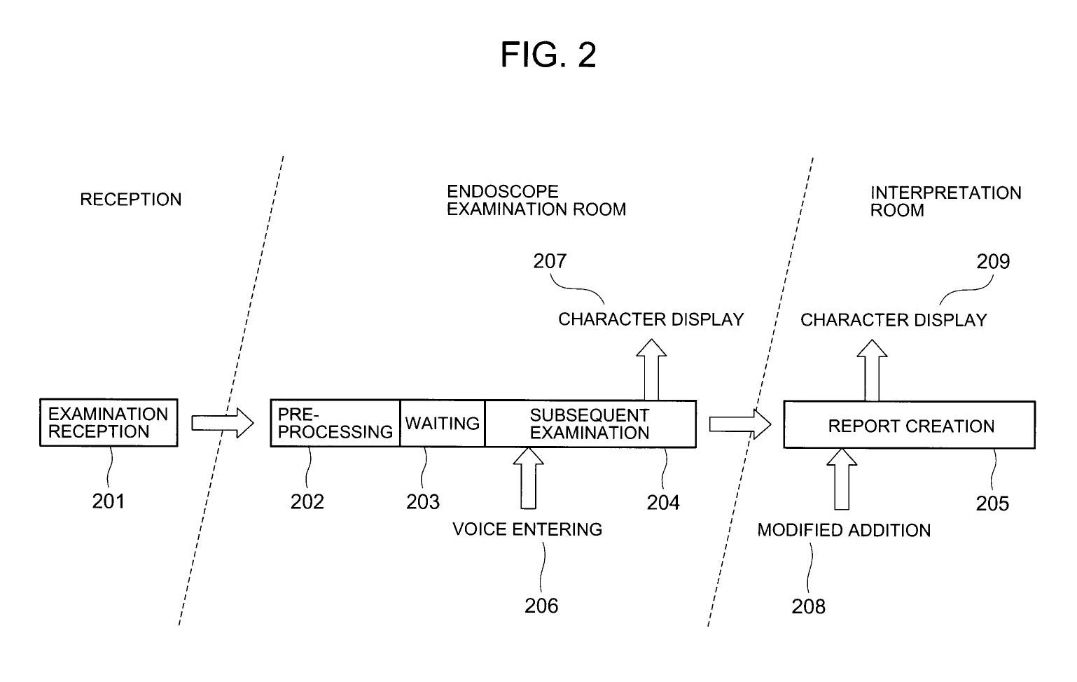

In the present embodiment, the case of displaying it in one display column of one application as a transformation condition is explained, while the embodiment may be configured to display characters transformed from voice in a plurality of display columns in a plurality of applications. For example, an examination by means of an endoscope is conducted as shown in FIG. 2. FIG. 2 shows flow of endoscope examination. First, an examination reception 201 is conducted at the reception. Next, pre-processing 202 at an endoscope examination room, waiting 203 until completion of preparing subsequent examination, and subsequent examination 204 are performed. In this examination 204, the doctor conducts voice entering 206 as well as the endoscope examination. Then, on the moment, character display 207 is performed at the display screen visible from the patient. Further, report creation 205 is performed at interpretation room.

Then, in the report creation 205, character display 209 is performed on the display screen invisible from the patient. Meanwhile, display at the examination 204 and the character display 209 at the report creation 205 may be conducted simultaneously. In this case, based on the transformation condition such as each application, different dictionaries are selected by the transformation controller 002.

Then, the transformation controller 001 refers to respective different dictionaries, so as to transform the voice to provide the character display 207 and the character display 209 on each display device 013. For example, when voice “red swelling” is entered, “red swelling” as the character display 207 is provided on the display device 013 of the examination 204. Further, when the report 401 shown in FIG. 4 is created in the report creation 205, “stomach cancer” in the disease name column 402 of the display device 013, “stomach cancer Boltzmann IIa suspected” in the comments section 403, and “physiologic examination required” in the treatment column 404 are displayed. Further, in the report creation 205, to the provided character display 209, the doctor may use the voice entering device 011 for modified addition 208 in order to complete the report 401.

Further, after creation of report 401, the report 401 is used for the doctor in the examining room to diagnose and explain the patient to create a medical report, and further addition and modification to the report 401 is conducted. In this case, the medical assistance device according to the present embodiment may be used in this examining room. In this case, the dictionary used for transforming entered voice into wordings of treatment policy or specialized medical terminology, is used. Then, when the voice “suspected” is entered as an example, it is transformed into “re-examination” or “operation required”.

Further, in the present embodiment, voice entered from the voice entering device 022 is transformed on the moment and displayed. As shown in broken line of FIG. 1, voice storage 006 is further prepared, which stores the entered voice without change when it is entered. Then, it may be configured to transform the voice when the operator uses the entering device 012 to enter the instruction of transformation.

As a result, a timing of transformation can be shifted. Further, although the transformation is not necessary at the time, a load to the device due to unnecessary transformation can be reduced. Therefore, based on the voice stored at the time of necessity of the doctor, it can be transformed into characters to be displayed, reducing the entering burden of the doctor. Further, it solves the anxiety of the patient due to the knowledge of the patient about essential meaning of the remarks by the doctor.

Further, in this embodiment, the term “red swelling” is explained as the ciphered term of “stomach cancer Boltzmann IIa suspected”, it may be applied similarly to the term which is not desirable to be directly shown to the patient. For example, the degree of symptom may be shown by means of adjective and the case, i.e. “white”, “red”, “welted”, “linear”, “circular”, and “spherical” are used as adjective for display, or “linear trail” and “spherical trail” are used as the case for display. Then, as a result of combination of the above terms, the term “white linear trail” is used as the ciphered term of the “cancer”, otherwise the terms such as “tissue is developed”, “appears as a sharp shading” and “rough spherical shaped” may be similarly used.

As explained above, according to the medical assistance device of the present embodiment, doctors do not have to enter the medical information manually, and can enter voice on the moment, so as to reduce the burden of the doctor in entering the medical information and memorizing. Further, the display content can be changed depending on the entered transformation condition, and the statistical voice recognition and the natural language processing are used to transform voice i n to characters, therefore precisely transforming it into proper characters. Further, the ciphered information is used to display the transformed language on screen without showing the language uttered depending on the situation of usage. As a result, medical assistance depending on the situation of usage can be provided.

### The Second Embodiment

Next, a medical assistance device of the second embodiment will be explained. The medical assistance device according to the present embodiment also includes the component shown in the block diagram of FIG. 1.

In the present embodiment, the medical assistance device manufacturer previously provides in the storage 004 a basic dictionaries group used for transforming voice into the same term. Then, the medical assistance device provides a plurality of terms in the storage 004 as previously ciphered terms. Further, depending a transformation condition for transforming entered voice into characters, including previously ciphered terms, an application for use and the display columns, the medical assistance device manufacturer associates a ciphered term with a term for returning the ciphered term to the original meaning on one to one, so as to provide the association table in the storage 004.

The recognition transformer 001, by means of basic dictionaries group stored in the storage 004, recognizes the voice entered from the voice entering device 011 without change.

The execution controller 003 receives entering by an operator using the entering device 012 or entering via the order information previously created at the time of diagnosis. Next, the execution controller 003 obtains the transformation condition for transforming into characters the entered voice, such as information of an application for use, the name of an operator, the specialty and the name of the site. Subsequently, the execution controller 003 obtains information of the display column from the application.

The transformation controller 002 refers to a list of terms used for a cipher stored in the storage 004 to determine whether the term is ciphered or not. When the term is ciphered, it receives the entered transformation condition from the execution controller 003, to sends an instruction of the association table usage and the transformation condition.

When the term received from the voice storage 006 is the ciphered term, the recognition controller 001 refers to the association table stored in the storage 004 for matching the transformation condition received from the transformation controller 002, so as to transform the term into corresponding characters. Next, it sends the characters to display controller 005. When the received term is not ciphered, the recognition controller 001 sends it to the display controller 005 without change.

Based on the application for use and the display column designated by the execution controller 003, the display controller 005 instructs the display device 013 to display characters received from the recognition controller 001.

Further, in the present embodiment, the transformation condition sent from the execution controller 003 is received by the transformation controller 002, and the instruction for the transformation controller 002 to use the association table is sent to the recognition controller 001. Alternatively, the transformation condition may be directly sent from the execution controller 001 to the recognition controller 001, so as to determine whether the association table is used or not.

As explained above, transformation from simply recognized language into the corresponding other language reduces the load of the voice recognition transformation processing as well as enables characters to be displayed by means of entered voice according to the transformation condition, accordingly reducing the burden of the doctor in entering the medical information. Further, the anxiety of the patient due to knowledge of the real meaning of the remarks of the doctor is prevented. Further, the transformation is enabled with low load, and the content can be displayed depending on the entered transformation condition, so as to provide the medical assistance according to the situation of usage.

What is claimed is:

1. A medical assistance device comprising:
a voice dictionary used for transforming voice into characters;
a storage configured to store cipher information indicating correspondence of terms included in the voice dictionary and the terms for ciphering;
a voice entering part configured to enter voice;
a transformer configured to transform the entered voice into a term string, based on the voice dictionary and the cipher information;
a display transformer configured to transform the transformed term string into information for display; and
a display controller configured to instruct a display device to display the information for display.

2. The medical assistance device according to claim 1, wherein
the storage is configured to store multiple kinds of the cipher information, and
the transformer is configured to select one from the multiple kinds of the cipher information to be used for transformation with the voice dictionary.

3. The medical assistance device according to claim 2, further comprising:
an entering part configured to enter a transformation condition, wherein
the transformer is configured to select one from the multiple kinds of the cipher information, based on the transformation condition.

4. The medical assistance device according to claim 3, wherein
the transformation condition is information showing a category of a display column, a site to be examined, a specialty of an operator, discrimination information of the operator, or an application that shows the medical information.

5. A medical assistance device comprising:
a voice dictionary used for transforming voice into characters;
a storage configured to storing cipher information (cipher table) indicating correspondence of terms included in the voice dictionary and the terms for ciphering;
a voice entering part configured to enter voice; a transformer configured to transform the entered voice into a term string, based on the voice dictionary and the cipher information;
a display transformer configured to transform the transformed term string into information for display; and
a display controller configured to instruct a display device to display the information for display, wherein
the transformer is configured to refer to correspondence of the term registered beforehand and other term string, for transformation into other term string.
